(19) United States
(12) Patent Application Publication
(10) Pub. No.: US 2018/0051667 A1
(43) Pub. Date: Feb. 22, 2018

(54) FLOWING WATER HYDROELECTRIC GENERATOR

(71) Applicants: Kai-Te YANG, Tainan (TW); Feng-Chih LIU, Tainan (TW)

(72) Inventors: Kai-Te YANG, Tainan (TW); Feng-Chih LIU, Tainan (TW)

(21) Appl. No.: 15/239,804

(22) Filed: Aug. 17, 2016

(51) Int. Cl. F03B 13/10; F03B 17/06; H02K 7/116; H02K 5/10; H02K 5/124; H02K 7/18

(52) U.S. Cl. CPC F03B 13/10; F03B 17/061; H02K 7/1823; H02K 5/10; H02K 5/124; H02K 7/116

(57) ABSTRACT

A flowing water hydroelectric generator is consisted of a motor attached by power cord, an overdrive gear set assembled on the motor's axial and couple fixed axles including a sun gear, several planet gears and a ring gear having a gear hole, a shaft able to be inserted through the gear hole, a housing installed on the motor able to block and seal the overdrive gear set on the motor and an impeller connected to the shaft. The generator can produce more power because of the motor's rotating speed-up driven by the overdrive gear set turned by the shaft spun by the impeller swiveled by flowing water and has a variety of installing combinations and easily be installed or removed. The best power generation efficiency can be achieved due to the generator's prolonged service life, small volume, great capacity and good transmission.

### BACKGROUND OF THE INVENTION

### 1. Field of the Invention

This invention relates to a flowing water hydroelectric generator, in particular to a hydroelectric generator consisted of a motor, an overdrive gear set, a shaft, a housing and an impeller. The generator can produce more power because of the motor's rotating speed-up driven by the overdrive gear set turned by the shaft spun by the impeller swiveled by flowing water. Furthermore, the invention has a variety of installing combinations in ditch or channel in order to fulfill surface of the ditch or channel and it is easily installed or removed. The motor is water proof to prolong its' service life and it has great capacity and good transmission so as to achieve the best power generation efficiency.

### 2. Description of the Prior Art

Commonly, a hydroelectric generator in ditch or river is consisted of a flowing device and a hollow housing including an impeller assembled with a transmitting chain underneath the flowing device able to be interacted with a motor defined on top of the flowing device. The impeller can be swiveled by flowing water to drive the transmitting chain interacting with the motor in order to produce power. However, the flowing device consisted of a motor and a housing including a transmitting chain is not only huge but also bad capacity, bad transmission and short service life. Additionally, the device is occupied lots of spaces in the ditch or river in case of installing, and its power generation efficiency is quiet limited so the economic benefit is not good either.

### SUMMARY OF THE INVENTION

The objective of a flowing water hydroelectric generator in present invention is able to produce more power by increasing rotating speed of a motor driven by an overdrive gear set. Furthermore, the generator has a variety of installing combinations in ditch so as to fulfill surface of the ditch and it is easily installed or removed. Moreover, the motor is water proof to prolong its' service life and it has great capacity and good transmission to achieve the best power generation efficiency.

The generator in the present invention is consisted of a motor attached by a power cord having an axial with a first positioning member defined on outer wall of the axial and couple fixed axles all deposed at one side of the motor and various supporting portions placed outer wall of the motor; an overdrive gear set able to be assembled on the axial and the fixed axles of the motor having a sun gear with a first groove deposed at inner wall of the sun gear, several planet gears and a ring gear having a gear hole with a second groove defined at inner wall of the gear hole at center of the ring gear; a shaft able to be inserted through the gear hole of the ring gear having a second positioning member at one end and both of a flange and a third positioning member located outer wall of the shaft and a threaded portion located at the other end; a housing able to block and seal the overdrive gear set on the motor having a chamber communicating with a bore and a bearing placed in the bore; and an impeller installed on the third positioning member of the shaft having a shaft hole with a third groove deposed at inner wall of the shaft hole and connected by a nose cone.

The generator in the present invention, wherein, plural threaded holes deposed at one side of the motor and plural perforations defined at one side of housing are corresponding to each other and a sealing ring is threaded on the housing.

The generator in the present invention, wherein, numerous threaded holes deposed at one end of the shaft can correspond and connect to a restrictive plate of the shaft by using some fasteners.

The generator in the present invention, wherein, the supporting portions are held by multiple rods assembled inside of a cover consisted of several sheets and a protective net in front of the cover.

The generator in the present invention, wherein, the cover is placed on a holder including a board and two lateral vertical bars.

### BRIEF DESCRIPTION OF DRAWINGS

This invention will be better understood by referring to the accompanying drawings, wherein:

FIG. 1 is first exploded perspective view of an exemplary embodiment of the present invention;

FIG. 2 is second exploded perspective view of an exemplary embodiment of the present invention;

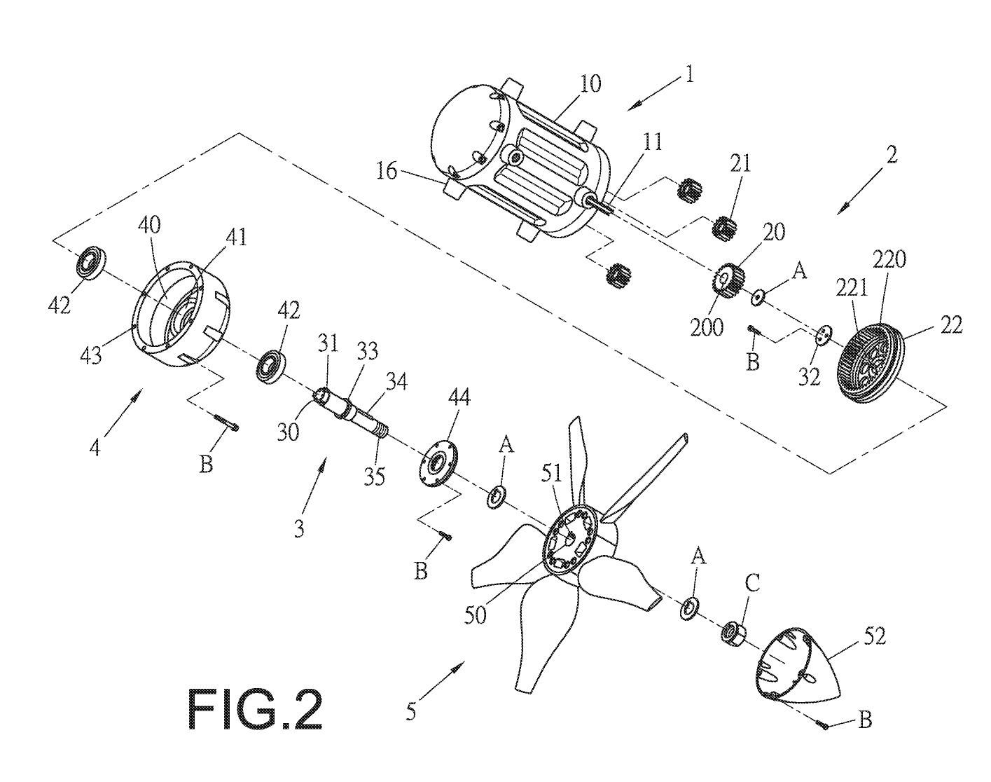

FIG. 3 is a perspective view of an exemplary embodiment of the present invention;

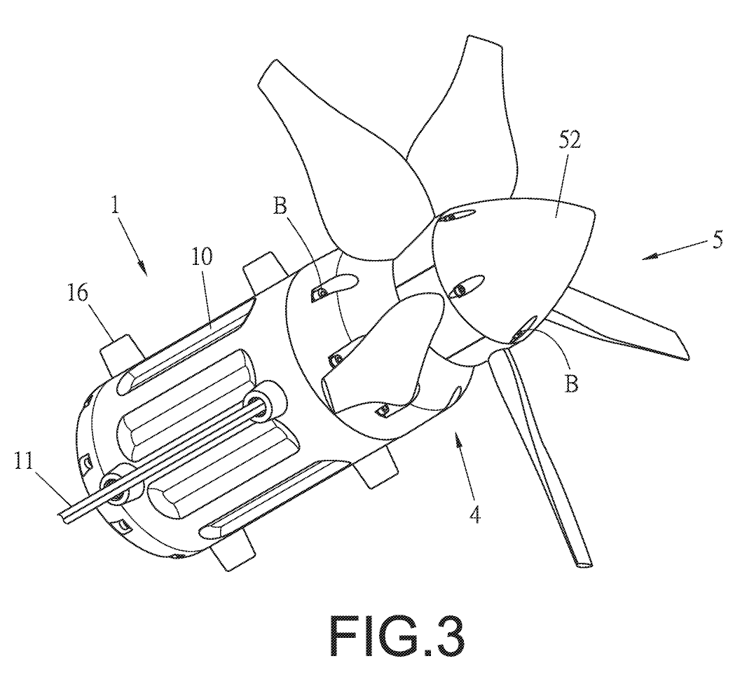

FIG. 4 is a cross-sectional view of an exemplary embodiment of the present invention;

FIG. 5 is a schematic view of an exemplary embodiment showing the present invention in condition of use, and

FIG. 6 is a schematic view illustrating an exemplary embodiment of the present invention in condition of use.

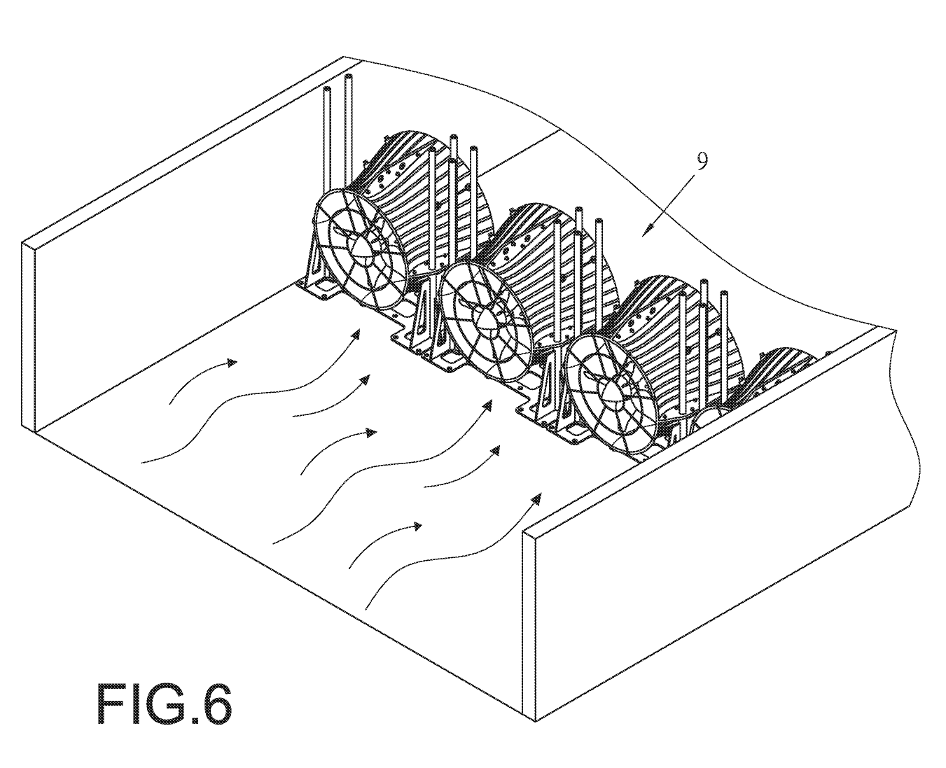

### DETAILED DESCRIPTION OF THE PREFERRED EMBODIMENTS

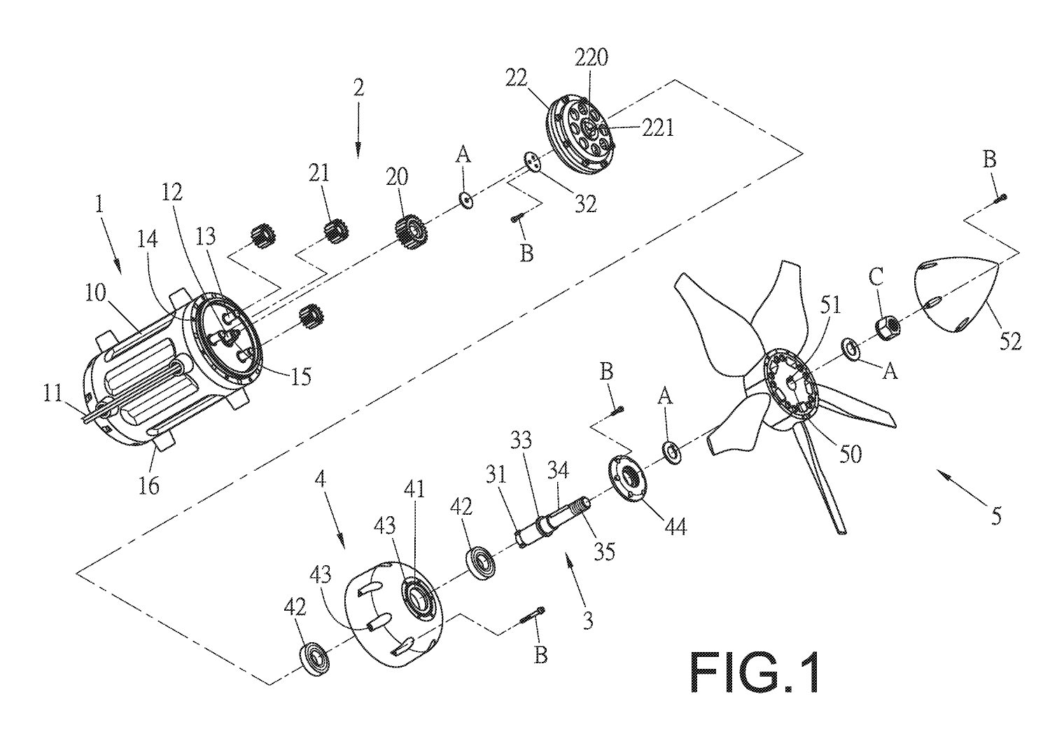

An exemplary embodiment of the present invention, referring to FIG. 1˜2, a flowing water hydroelectric generator 9 in present invention mainly comprises a motor set 1, an overdrive gear set 2, a shaft 3, a housing 4 and an impeller 5. The motor set 1 is consisted of a motor 10 attached with a power cord 11 having an axial 12, couple fixed axles 13 and plural threaded holes 14. At wall of the axial 12 is deposed a first positioning member 15. At outer wall of the motor 10 is defined various supporting portions 16. The overdrive gear set 2 assembled on the axial 12 and the fixed axles 13 includes a sun gear 20, several planet gears 21 and a ring gear 22. At inner wall of the sun gear 20 is defined a first groove 200. At center of the ring gear 22 is defined a gear hole 220 which has a second groove 221 at inner wall of the gear hole 220. The shaft 3 inserted through the gear hole 220 of the gear ring 22 has numerous threaded holes 30 able to correspond and connect to a restrictive plate 31 by using some fasteners B and a second positioning member 31 at one end. At outer wall of the shaft 3 is deposed a flange 33 and a third positioning member 34. At the other end of the shaft 3 is defined a threaded portion 35. The housing 4 assembled on the motor 10 to seal and block the overdrive gear set 2 has a chamber 40 communicating with a bore 41. A bearing 42 placed inside of the bore 41 is inserted on the shaft 3. At one side of the housing 4 are deposed plural perforations 43. The housing 4 is threaded and connected by a sealing ring 44. The impeller 5 assembled on the third positioning member 34 of the shaft 3 has a shaft hole 50 with a third groove 52 located at the inner wall of the shaft hole 50. The impeller 5 is connected by a nose cone 52.

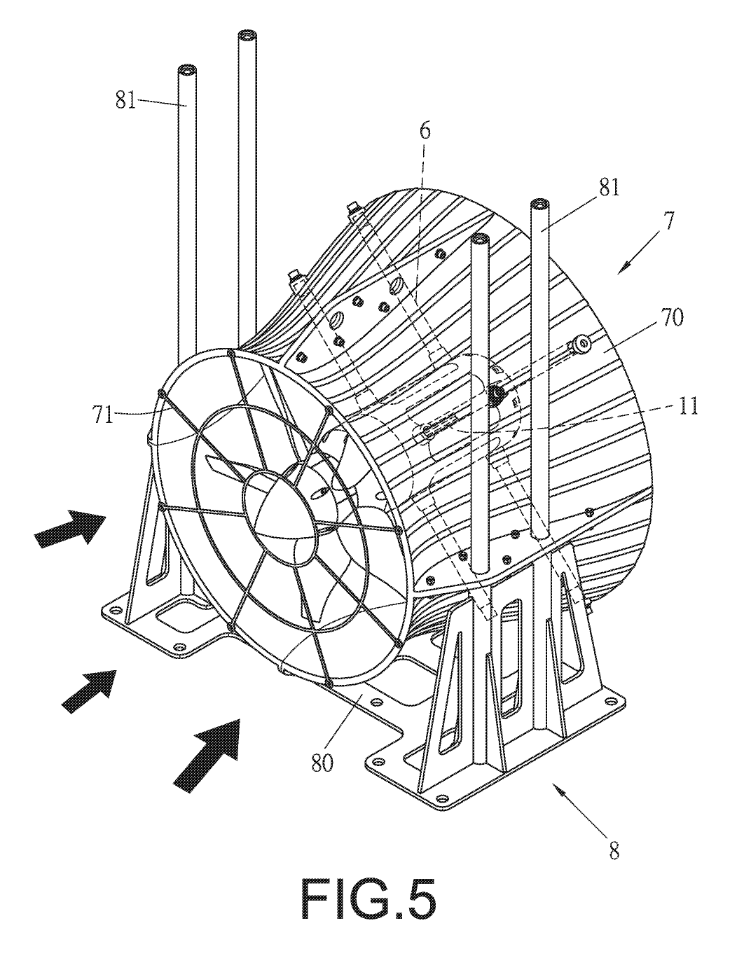

While assembling, referring to FIG. 1˜4, the sun gear 20 and the planet gears 21 of the overdrive gear set 2 are respectively placed on the axial 12 and the fixed axle 13 of the motor 10 so the first positioning member 15 of the axial 12 is able to be inserted into the first groove 200 of the sun gear 20 and a washer A is used to fix them together. Then, the shaft 3 is protruded through the bore 41 and the bearing 42 of the housing 4 so the shaft 3 is located in the chamber 40 of the housing 4 and extended out of the bore 42 of the housing 4. The second positioning member 31 of the shaft 3 is reached and assembled on the second groove 221 and the gear hole 220 of the ring gear 22. The threaded holes 30 of the shaft 3 is secured and threaded with a restrictive plate 32 by the fasteners B so as to the ring gear 22 can be positioned in the chamber 40 of the housing 4. The housing 4 is mounted on the motor 10 by the fasteners B threaded through the perforations 43 of the housing 4 and secured on the threaded holes 14 of the motor 10 in order to seal and block the overdrive gear set 2. The sealing ring 44 is fixed on the on housing 4 by the fasteners B threaded on the rest of the perforations 43. After placing a washer A on the shaft 3, the third positioning member 34 of the shaft 3 is inserted through the third groove 51 and the shaft hole 50 of the impeller 5 and another washer A is placed on the shaft 3. A nut C is used to be secured on the threaded portion 35 of the shaft 3. The nose cone 52 is threaded in front of the impeller 5 by the fasteners B. Referring to FIG. 5, the supporting portions 16 of the motor 10 are held by multiple rods 6 which one of the rods 6 is used to sleeve around the power cord 11. The rods 6 is located inside of a cover 7 consisted several sheets and a protective net 71 in front of the cover 7. The cover 7 is placed on a holder 8 including a board 80 and two lateral vertical bars 81.

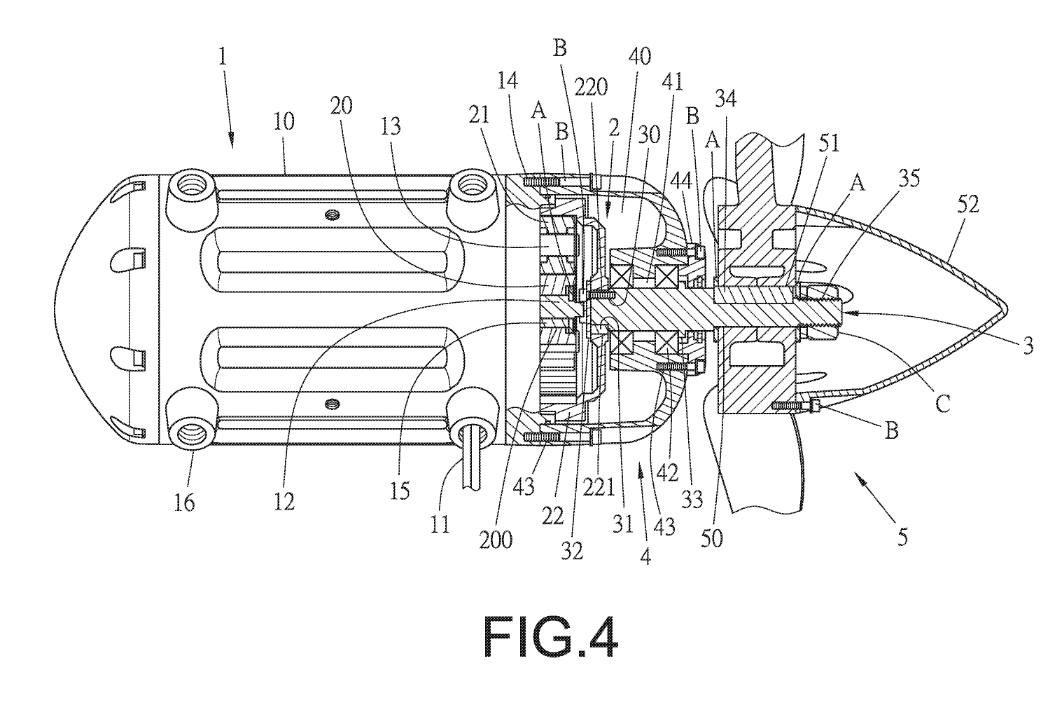

While using, referring to FIG. 4˜6, all it has to do is let flowing water drive the impeller 5 and the nose cone 52 swiveling so that the impeller 5 can interact with the shaft 3 spinning because the third positioning member 34 of the shaft 3 is secured on the third groove 51 and the shaft hole 50 of the impeller 5. By having the second position member 31 of the shaft 3 secured on the second groove 221 and the gear hole 220 of the ring gear 22, the shaft 3 can turn the ring gear 22 around so that the ring gear 22 can drive the planet gears 21 rotating and then the planet gears 21 can interact with the sun gear 20 which means the overdrive gear set 2 is meshed to run. Due to the first positioning member 15 of axial 12 of the motor 10 is secured in the first grove 200 of the sun gear 20, the sun gear 20, the planet gears 21 and the ring gear 22 of the overdrive gear set 2 can drive the motor 10 speeding up in order to produce more power. Furthermore, the flowing water hydroelectric generator 9 in the present invention has a variety of installing combinations in the ditch or channel in order to fulfill surface of the ditch or channel and it is easily installed or removed. The motor 10 is completely water proof to prolong its' service life and it has great capacity and good transmission so as to achieve the best power generation efficiency.

While the preferred embodiments of the present invention have been described above, it will be recognized and understood that various modifications may be made therein and that the claims are intended to cover all such modifications that may fall within the spirit and scope of the invention.

What is claimed is:

1. A flowing water hydroelectric generator is consisted of
a motor attached by a power cord having an axial with a first positioning member defined on outer wall of the axial and couple fixed axles all deposed at one side of the motor and the various supporting portions on placed outer wall of the motor;
an overdrive gear set able to be assembled with the axial and the fixed axles of the motor having a sun gear with a first groove deposed at inner wall of the sun gear, several planet gears and a ring gear having a gear hole with a second groove defined at inner wall of the gear hole at center of the ring gear;
a shaft able to be inserted through the gear hole of the ring gear having a second positioning member at one end and both of a flange and a third positioning member located outer wall of the shaft and a threaded portion located at the other end;
a housing able to block and seal the overdrive gear set on the motor having a chamber communicating with a bore and a bearing placed in the bore; and
an impeller installed on the third positioning member of the shaft having a shaft hole with a third groove deposed at inner wall of the shaft hole and connected by a nose cone.

2. The flowing water hydroelectric generator as claimed in claim 1, wherein, plural threaded holes deposed at one side of the motor and plural perforations defined at one side of housing are corresponding to each other and a sealing ring is threaded on the housing.

3. The flowing water hydroelectric generator as claimed in claim 1, wherein, numerous threaded holes deposed at one end of the shaft are able to correspond and connect to a restrictive plate of the shaft by using fasteners.

4. The flowing water hydroelectric generator as claimed in claim 1, wherein, the supporting portions are held by multiple rods assembled inside of a cover consisted of several sheets and a protective net in front of the cover.

5. The flowing water hydroelectric generator as claimed in claim 1, wherein, the cover is placed on a holder including a board and two lateral vertical bars.
